(19) United States
(12) Patent Application Publication
(10) Pub. No.: US 2016/0245017 A1
(43) Pub. Date: Aug. 25, 2016

(54) DRIVE SYSTEM FOR A CORDLESS BLIND

(71) Applicant: Yao-Tsung Chen, Chatham, NJ (US)

(72) Inventor: Yao-Tsung Chen, Chatham, NJ (US)

(21) Appl. No.: 15/041,288

(22) Filed: Feb. 11, 2016

Related U.S. Application Data
(60) Provisional application No. 62/120,237, filed on Feb. 24, 2015.

(51) Int. Cl. E06B 9/322

(52) U.S. Cl. CPC E06B 9/322

(57) ABSTRACT

A drive system for a window treatment blind provides cordless operation of the blind in that the blind may be moved between a retracted position and an extended position without the typical user activation of a lift cord. The drive system includes an actuator with a spring tensioned spool that winds the lift cord as the blind is retracted and unwinds the lift cord as the blind is extended. The drive system eliminates the strangulation hazard to children presented by conventional lift cords.

### CROSS-REFERENCE TO RELATED APPLICATION

This application claims the benefit of priority of U.S. provisional application No. 62/120,237, filed Feb. 24, 2015, the contents of which are herein incorporated by reference.

### BACKGROUND OF THE INVENTION

The present invention relates to the lift system of window covering. More particularly, the present invention relates to mechanisms for operating blinds, cellular shades, and roman shades.

Conventional window treatments, such as louvered blinds presently on the market typically use a pull cord to raise or lower blind. These cords extend from a front face of the operating mechanism and dangle, presenting an attractive nuisance for small children. The attraction becomes more pronounced when the window treatment is in the raised position, when a greater length of the cord is withdrawn and dangles within the reach of children. Regrettably, these lift cords can present a danger to small children, particularly for inadvertent strangulation.

As can be seen, there is a need for an improved lifting mechanism for louvered blinds and window treatments that eliminate strangulation hazards for small children.

### SUMMARY OF THE INVENTION

In one aspect of the present invention, blind for a window or other opening comprises: a top rail having a channel formed therein; a bottom rail; a plurality of slats disposed between the top rail and the bottom rail; a lift cord having a first end operatively attached to the bottom rail and received through an aperture defined through each of the plurality of slats; and an actuator having a spring tensioned spool operatively attached to a second end of the lift cord and adapted for alternately winding and unwinding the lift cord as the blind is moved between an extended position to a retracted position. The actuator may further include an actuator housing; a shaft extending between an internal surface of the actuator housing; and the spring tensioned spool is contained within the actuator housing for rotation about the shaft. The spring tensioned spool may have a cavity defined therein containing a spring operatively coupled between the spool and the shaft. The spring may be a tape spring. In some embodiments, the spring tensioned spool has a lift cord slot defined in a portion of an outer surface of the spool. In other embodiments, the spring tensioned spool has a lift cord slot defined in a substantial portion of an outer surface of the spool. The lift cord slot may also be divided by an annular plate.

In other aspects of the invention, the blind may further comprise: a tilt cord operatively connected between a forward portion of the bottom rail, an aft portion of the bottom rail, and a tilt drum; and a tilt rod operable to rotate the tilt drum and impart a tilting in the bottom rail. The blind may further include a plurality of spaced apart holes defined in a forward portion and an aft portion of the plurality of slats; wherein the tilt cord is received through the plurality of spaced apart holes; and the plurality of slats tilt in unison with a rotation of the tilt drum.

In yet other aspects of the invention a blind comprises: a plurality of slats disposed between a top rail and a bottom rail; a lift cord having a first end operatively attached to the bottom rail and received through an aperture defined through each of the plurality of slats; and a spring tensioned actuator operatively attached to a second end of the lift cord and adapted for alternately winding and unwinding the lift cord about a spool as the blind is moved between an extended position to a retracted position. The actuator may further include an actuator housing; a shaft extending within the actuator housing, wherein the spool received on and is rotatable about the shaft; a spring received in a cavity defined within the spool; and the spring is operatively coupled between the spool and the shaft. The spring may be a tape spring. In some embodiment, the spool has a lift cord slot defined across a portion of an outer surface of the spool. In other embodiments, the spool has a lift cord slot defined across a substantial portion of an outer surface of the spool. In other embodiments, the lift cord slot is divided by an annular plate.

In yet another aspect of the invention, an actuator for a window treatment blind, is provided which includes: an actuator housing; a spool adapted for rotation about a shaft within the actuator housing; an aperture in an outer surface of the actuator housing adapted to receive a lift cord for positioning the window treatment blind between a retracted position and an extended position; and a spring operably attached between the spool and the shaft, wherein the spring is placed under tension with the window treatment positioned in the extended position. The spring may be placed under a reduced tension with the window treatment positioned in the retracted position. The lift cord is substantially contained within the actuator in the retracted position.

These and other features, aspects and advantages of the present invention will become better understood with reference to the following drawings, description and claims.

### BRIEF DESCRIPTION OF THE DRAWINGS

FIG. 1 is a detail perspective view of the invention shown in retracted configuration.

FIG. 2 is a detail perspective view shown in expanded configuration.

FIG. 3 is a detail perspective view of the invention.

FIG. 4 is a detail exploded view of the invention component item 10 actuator.

FIG. 5 is a section detail view of the invention along line 5-5 in FIG. 1.

FIG. 6 is a section detail view of the invention along line 6-6 in FIG. 2.

FIG. 7 is a section detail view of the invention along line 7-7 in FIG. 5.

FIG. 8 is a section detail view of an alternate embodiment of the invention.

FIG. 9 is a section detail view of an alternate embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a drive system and a window treatment blind that provides for cordless operation of the blind in that the blind may be moved between a retracted position and an extended position without the typical user activation of a lift cord. The drive system includes an actuator with a spring tensioned spool that winds the lift cord as the blind is retracted and unwinds the lift cord as the blind is extended. Because the lift cord is contained on the spool, the drive system eliminates the strangulation hazard to children presented by conventional lift cords.

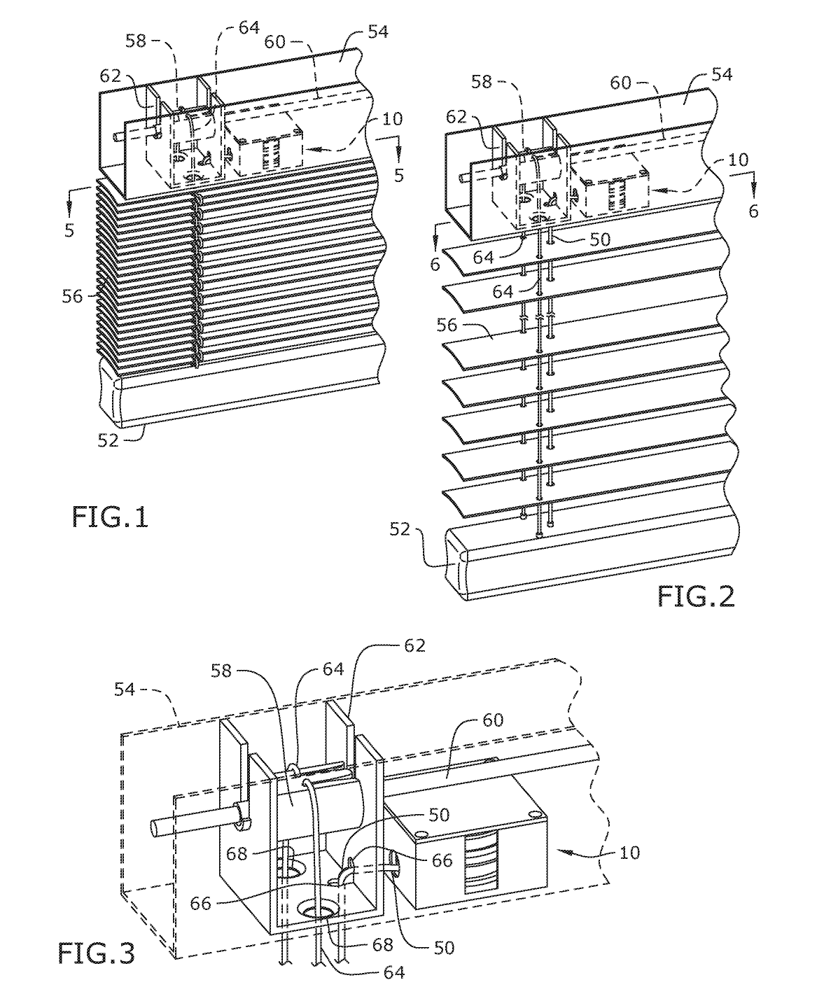

As best seen in reference to FIG. 1 a blind according to the present invention is shown in a retracted position in which the blind is retracted to permit visibility through a substantial portion of a window or opening for which it is intended to cover. The blind may include a top, or head rail 54, and a bottom rail 52. The head rail 54 is configured to contain the actuator and other operating components of a window blind of the present invention. A plurality of movable louvers, or slats 52, are disposed between the top rail 54 and the bottom rail 52. As seen in reference to FIG. 2, the blind is shown in an extended position in which the blind and the plurality of slats 56 are extended to cover at least a portion of the window or opening for which it is intended to cover.

As will be appreciated, the blind may selectively positioned between the retracted position, the extended position, and any intermediate position there between via lift cord 50 having a first end operably connected to the bottom rail 52, such that as the lift cord is pulled, the bottom rail 52 is raised and urges the slats 56 towards the top rail 54. As contemplated by the present invention, the lift cord 50 is threaded through an aperture defined through a top and bottom surface of each of the plurality of slats. The threaded arrangement facilitates maintaining the vertical and lateral alignment of the slats 56 as they are moved during operation of the blind.

In further reference to FIG. 3, a second end of the lift cord 50 is routed through a lift cord aperture 66 defined in the head rail 54 and operably attached to an actuator 10 that is operable to retract and retain the lift cord 50 when the blind is moved to the retracted position and to dispense the lift cord when the blind is moved to the extended position.

The blind may also include a tilt mechanism that is operable to selectively position the plurality of slats 56 between a substantially horizontal position and a substantially vertical position. The tilt mechanism includes a tilt cord 64 that has a first end connected to an outer portion of the bottom rail 52 and a second end that is connected to an inner portion of the bottom rail 52. The tilt cord 64 is routed through the slats 56 via a pair of spaced apart holes extending through an outer portion of the slats 56 and an inner portion of the slats 56. The tilt cord 64 is also routed through the top rail 54 via a tilt rod drum hole 68 defined in the top rail. The tilt cord 64 is preferably a unitary length of cord that is retained at an intermediate point of the tilt cord 64 to a tilt rod drum 58.

The tilt rod drum 58 is positioned within a tilt rod bracket 62, and may be rotated by a tilt rod 60, extending through a rotational axis of the tilt rod drum 58. The tilt rod 60 is operable to rotate the tilt rod drum 58 such that the first and second ends of the tilt cord 64 are alternately raised or lowered depending upon the direction of rotation of the tilt rod drum 58, such that the slats 56 may be selectively positioned between the horizontal and vertical positions.

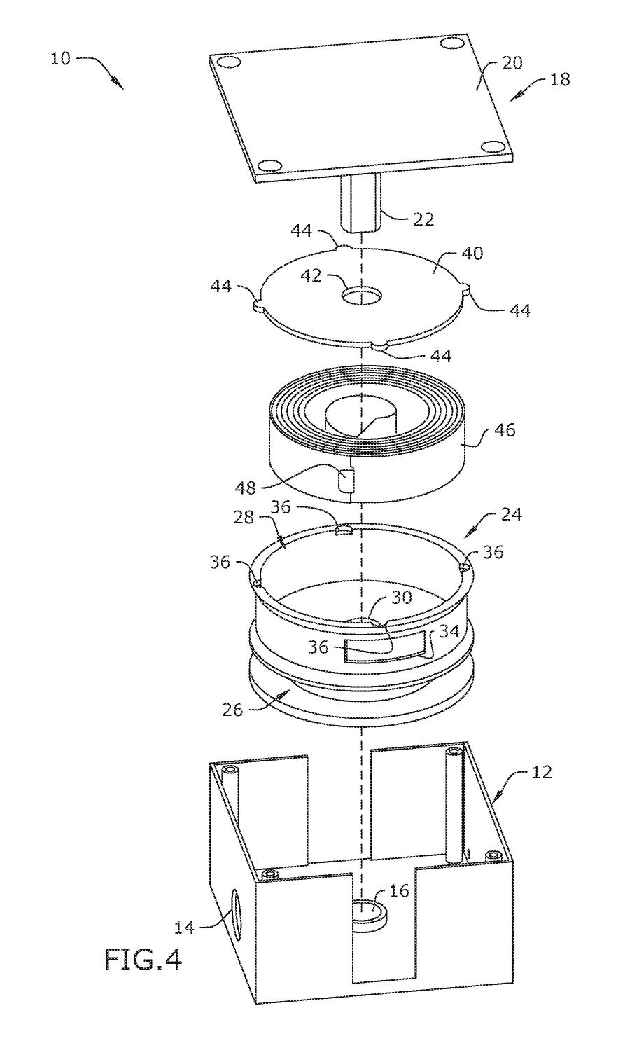

In further reference to FIG. 4, the actuator 10 includes an actuator housing 12 for containing the actuator components. A lift cord hole 14 is defined through a surface of the housing 12 so that the lift cord 50 may be routed into the actuator 10. The actuator 10 may also include an actuator housing cover 20 that coupled to the actuator housing 12 so as to contain the actuator components.

The actuator components may include an actuator spool body 23 having a lift cord wind slot 26 defined on a portion of the spool body 23. The lift cord wind slot 26 is adapted to receive the lift cord 50 in a wound relation within the slot 26 as the spool is rotated. The actuator spool body 24 may be formed as a substantially hollow body defining a spring chamber 28 therein.

The spring chamber 28 is adapted to receive a wound spring element 46 therein. The spring element 46 has a spring hook 48 defined at a first end of the spring 46 that is operably connected to a spring hook slot 34 defined in a surface of the spool body 23. A second end of the spring 46 is operatively attached to an actuator shaft 22 that extends within the actuator body 12. The second end of the spring 46 may be attached to the actuator shaft 22 via a fastener 32, such as a screw, pin, rivet, or optionally a second hook arrangement. The spring 46 may be contained within the spring chamber 28 via a spool cover 40 and a side face of the spool body 28.

The spool cover 40 has a spool aperture 42 that is coaxially aligned with a rotational axis of the spool body 24. A second spool aperture may be defined in the side face of the spool body 24 and coaxially aligned with the rotational axis of the spool body 24. The spool cover 40 may be coupled to the end of the spool body 24 by the cooperative engagement of one or more tabs 44 extending from the spool cover 40 and a corresponding notch 36 defined in the spool body 24.

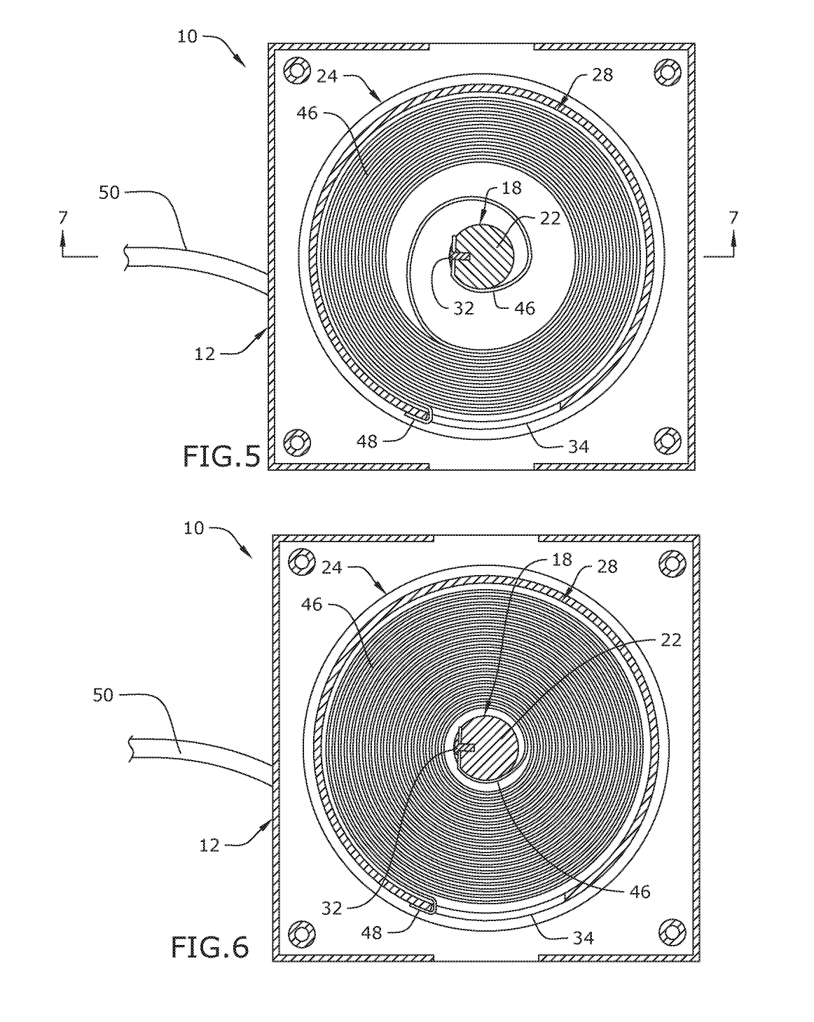

As seen in reference to FIG. 5, the actuator 10 is depicted with the blinds in a retracted condition. In this condition, the lift cord 50 is wound about the spool 28 within the spool slot 26. The spring element 46 is shown in a relaxed condition, which may include a partial tensioning of the spring element within the actuator so as to retain the blind in the retracted condition.

As seen in reference to FIG. 6, the actuator 10 and spring 46 depicted with the blinds in an extended condition. In this condition, the lift cord 50 is withdrawn from the spool 28 and the actuator 10. As the lift cord 50 is withdrawn from the spool 28, the tension on the spring element 46 is increased. The tension imparted on the spring element 46 will provide sufficient force so as to rotate the spool 28 and wind the lift cord 50 about the spool when the blind is raised. The tension should also be sufficient so as to maintain the position of the bottom rail 52 at any intermediate position between the retracted and extended position such that the blind will maintain its position as selected by a user.

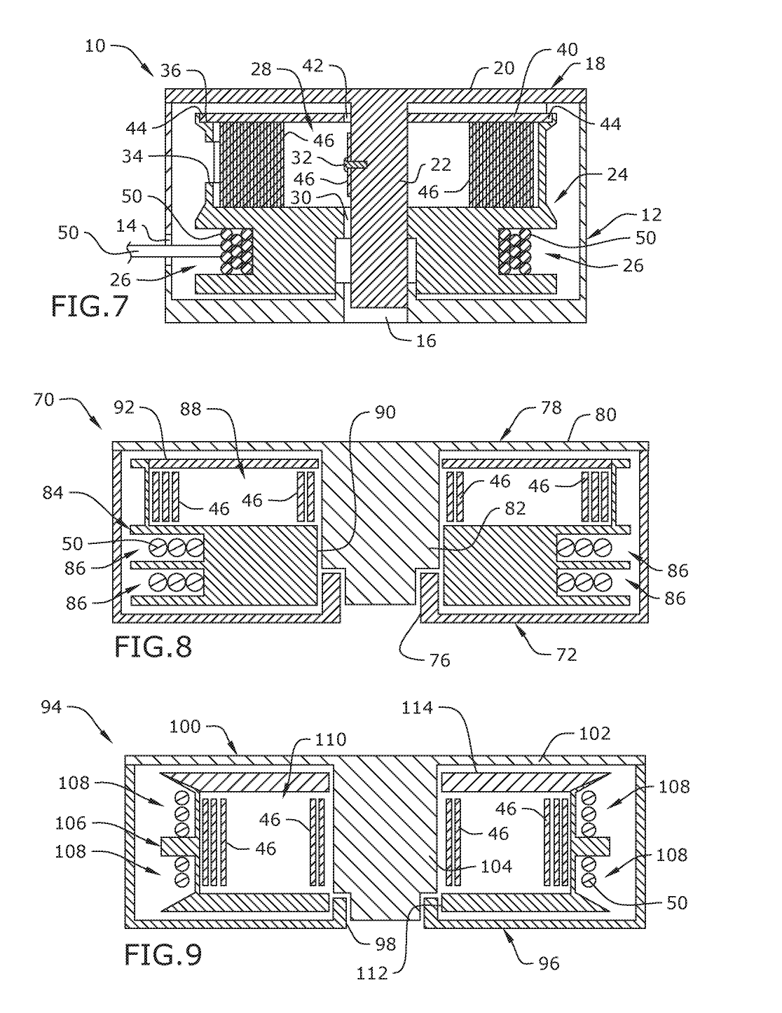

As seen in reference to FIG. 7, a cross sectional view of an actuator 10 is depicted. The lift cord 50 enters the actuator 10 through a sidewall of the actuator case body 12 via the case body lift cord hole 14. The lift cord 50 winds around the wind slot 26 of the spool body 24 so as to retract and retain the lift cord 50 within the actuator 10. Because the lift cord 50 is retained in the actuator, the blind of the present invention avoids the presence and associated child hazards presented by conventional lift cords.

The actuator shaft 22 extends between the interior ends of the actuator body 12. In the embodiment shown, the shaft 22 may be integrally formed with the actuator body cover 18 and extends and is received within a actuator shaft shaft hole 16 defined in an opposite face of the body 12. The spool body 24 has a hub 30 which receives the shaft 22 therein for rotation of the spool body 24 about the shaft 22 during operation. As indicated, previously, the spool cover 40 may also have an aperture 42 providing a corresponding hub at an end of the spool body 24 for rotation about the shaft 22. The spring 46 is shown within the spool spring chamber 28 and is operatively attached between the spool body 24 and the spool shaft 22.

As seen in an alternative embodiment of an actuator 70, depicted in reference to FIG. 8, the actuator 70 includes an actuator case body 72 to contain the components of the actuator 70. The case body 72 may also be provided with a shaft hub 76 to receive a first end of the actuator spool shaft 82 disposed between the interior sidewalls of the case body 72. The shaft 82 may be integrally formed with a case body cover 80 attached to an opposite end of the case body 72. The spool 84 may have a hub 90 that receives the shaft 82 for rotation about the shaft 82. The spool 84 may include a plurality of lift cord slots 86 separated by an annular plate between adjacent slots 86. The slots are adapted to receive the lift cord 50 in a wound arrangement during operation of the blinds. An internal spool cavity 88 is defined to receive the spring 46, which is operatively connected between the spool 86 and the shaft 82.

As seen in a second alternative embodiment of an actuator 94 depicted in reference to FIG. 9, the actuator 94 includes an actuator case body 96 to contain the components of the actuator 94. The case body 96 may also be provided with a shaft hub 98 to receive a first end of the actuator spool shaft 104 disposed between the interior sides of the case body 96. The shaft 104 may be integrally formed with a case body cover 100 and a case body plate 102 attached to an opposite end of the case body 96. The spool 106 may have a hub 112 that receives the shaft 104 for rotation of the spool 106 about the shaft 104. The spool 106 may include a plurality of lift cord slots 108 separated by an annular plate between adjacent slots 108. The slots 108 may extend across a substantial portion of the exterior surface of the spool 106. The slots 108 are adapted to receive the lift cord 50 in a wound arrangement during operation of the blinds. The internal spool cavity 110 is defined to receive the spring 46, which is operatively connected between the spool 106 and the shaft 104. A spool end plate 114 may also be attached to an open end of the spool 106 to contain the spring 46 therein.

In operation, as a user raises the bottom rail 52 of the blind, tension applied to the spring 46 will cause the spool 24, 84, 106 to rotate about the shaft 22, 82, 104 and wind the lift cord 50 about the spool within the spool slot 26, 86, 108 within the actuator housing. Because the lift cord 50 is retained within the actuator, the free ends of the lift cord 50 that previously presented a hazard to children has been eliminated. In addition, the actuator of the present invention eliminates hides the lift cord 50 from view, thereby presenting a more attractive, cordless appearance. When the blind is lowered to the extended position, the withdrawal of the lift cord 50 from the spool as it is drawn by the bottom rail 52 imparts tension in the spring 46 so that it is once again loaded to retract the lift cord 50.

It should be understood, of course, that the foregoing relates to exemplary embodiments of the invention and that modifications may be made without departing from the spirit and scope of the invention as set forth in the following claims.

What is claimed is:

1. A blind, comprising:
a top rail having a channel formed therein;
a bottom rail;
a plurality of slats disposed between the top rail and the bottom rail;
a lift cord having a first end operatively attached to the bottom rail and received through an aperture defined through each of the plurality of slats; and
an actuator having a spring tensioned spool operatively attached to a second end of the lift cord and adapted for alternately winding and unwinding the lift cord as the blind is moved between an extended position to a retracted position.

2. The blind of claim 1, wherein the actuator further comprises:
an actuator housing;
a shaft extending between an internal surface the actuator housing; and
the spring tensioned spool contained within the actuator housing for rotation about the shaft.

3. The blind of claim 2, wherein the spring tensioned spool has a cavity defined therein containing a spring operatively coupled between the spool and the shaft.

4. The blind of claim 3, wherein the spring is a tape spring.

5. The blind of claim 3, wherein the spring tensioned spool has a lift cord slot defined in a portion of an outer surface of the spool.

6. The blind of claim 3, wherein the spring tensioned spool has a lift cord slot defined in a substantial portion of an outer surface of the spool.

7. The blind of claim 5, wherein the lift cord slot is divided by an annular plate.

8. The blind of claim 2, further comprising:
a tilt cord operatively connected between a forward portion of the bottom rail, an aft portion of the bottom rail, and a tilt drum; and
a tilt rod operable to rotate the tilt drum and impart a tilting in the bottom rail.

9. The blind of claim 8, further comprising:
a plurality of spaced apart holes defined in a forward portion and an aft portion of the plurality of slats;
wherein the tilt cord is received through the plurality of spaced apart holes;
and the plurality of slats tilt in unison with a rotation of the tilt drum.

10. A blind, comprising:
a plurality of slats disposed between a top rail and a bottom rail;
a lift cord having a first end operatively attached to the bottom rail and received through an aperture defined through each of the plurality of slats; and
an spring tensioned actuator operatively attached to a second end of the lift cord and adapted for alternately winding and unwinding the lift cord about a spool as the blind is moved between an extended position to a retracted position.

11. The blind of claim 10, wherein the actuator further comprises:
an actuator housing;
a shaft extending within the actuator housing, wherein the spool received on and is rotatable about the shaft;
a spring received in a cavity defined within the spool; and
wherein the spring is operatively coupled between the spool and the shaft.

12. The blind of claim 11, wherein the spring is a tape spring.

13. The blind of claim 10, wherein the spool has a lift cord slot defined across a portion of an outer surface of the spool.

14. The blind of claim 10, wherein the spool has a lift cord slot defined across a substantial portion of an outer surface of the spool.

15. The blind of claim 13, wherein the lift cord slot is divided by an annular plate.

16. An actuator for a window treatment blind, comprising:
an actuator housing;
a spool adapted for rotation about a shaft within the actuator housing;
an aperture in an outer surface of the actuator housing adapted to receive a lift cord for operably positioning the window treatment blind between a retracted position and an extended position; and
a spring operably attached between the spool and the shaft, wherein the spring is placed under tension with the window treatment positioned in the extended position.

17. The actuator of claim 16, wherein the spring is under a reduced tension with the window treatment positioned in the retracted position.

18. The actuator of claim 17, wherein the lift cord is substantially contained within the actuator in the retracted position.
